(19) United States
(12) Patent Application Publication
(10) Pub. No.: US 2024/0141507 A1
(43) Pub. Date: May 2, 2024

(54) LOCALIZED GREEN HYDROGEN SYSTEM

(71) Applicant: Michael J. Smith, Northville, MI (US)

(72) Inventor: Michael J. Smith, Northville, MI (US)

(21) Appl. No.: 18/272,192

(22) PCT Filed: Feb. 1, 2022
(86) PCT No.: PCT/US22/14657

§ 371 Date: Jul. 13, 2023

Related U.S. Application Data
(60) Provisional application No. 63/146,265, filed on Feb. 5, 2021.

(51) Int. Cl. C25B 1/04; B60S 5/02; C25B 9/65; C25B 15/08; F17C 5/06; F17C 7/00; H02S 10/40

(52) U.S. Cl. CPC C25B 1/04; B60S 5/02; C25B 9/65; C25B 15/08; F17C 5/06; F17C 7/00; H02S 10/40; F17C 2221/011; F17C 2221/012; F17C 2227/0135; F17C 2227/0355; F17C 2265/065

(57) ABSTRACT

The present application discloses a uniquely-sited electrolysis plant for converting water to molecular hydrogen and molecular oxygen. The electrolysis plant is powered by a renewable-energy generator. In the preferred embodiment, the renewable-energy generator is a solar-cell array, preferably perovskite-enhanced solar panels, and is located in or on a non-navigable body of water or a non-navigable portion of a body of water. The electrolysis plant supplies hydrogen to a nearby transportation refueling station and/or to a nearby industrial or commercial facility. In an embodiment of the invention, the renewable-energy generator is a wind turbine used instead of solar power to power the electrolysis plant.

### CROSS REFERENCE TO RELATED APPLICATIONS

This application claims the benefit of U.S. Provisional Patent Application No. 61/314,265, filed on Feb. 5, 2021, the disclosure of which is incorporated by reference herein for all purposes.

### BACKGROUND OF THE INVENTION

The present invention relates to a hydrogen transportation refueling station or a hydrogen-powered power plant or manufacturing plant, using an electrolysis plant powered by solar panels located near a non-navigable body of water.

Every 100 years or so the world goes through an energy transition phase. In the 1700s, wood was the source of energy for cooking and heating. In the 1800s, coal took over from wood as the dominant fuel in part due to the invention of the steam engine. Oil was discovered in Titusville, PA in 1859 and in 1950, petroleum overtook coal as the main source of energy. These energy transition phases are also accompanied by phase changes of the fuel sources themselves from solid, to liquid, and now to the gas phase.

We have now entered the gas phase of the energy transition. The application and expansion of high-volume hydraulic fracturing has opened vast new supplies of both natural gas and oil from what geologists term “tight deposits.” The rapid development of fracking within shale deposits has elevated the United States from a country whose petroleum resources were in decline, to the world's number one energy producer, reaching approximately 13M bbls of oil per day in January 2020.

Since the 1700s, however, the amount of spent carbon from using fossil-fuel energy sources has accumulated in Earth's upper atmosphere, creating a barrier which has been called the “Greenhouse Effect.” This barrier of carbon dioxide from fossil fuel combustion, along with other greenhouse gases, creates a trapping mechanism where heat and water vapor cannot escape. This mechanism causes what is now known worldwide as global warming. One solution to global warming is solar power.

The cost for installing solar power has been dropping very fast since 2011. By 2022 the cost for renewable energy generated by solar (and wind) will fall below energy costs generated by fossil fuels, in most cases.

At least 100 watts of energy strike each square foot of Earth's surface in a fully-sunlit hour. Most areas of the U.S. receive the equivalent of four hours of full sunlight per day, translating into about 1.5 trillion terawatt-hours (“TWh”) of energy per year, many times the 4,300 TWh used in the U.S.

Solar cells (modules) made currently, however, can only convert about 22% of the absorbed light into electricity. Solar cells will likely eventually reach a conversion efficiency of 33 percent (33%) to a physics constraint called the Shockley-Queisser limit, the maximum theoretical efficiency of a solar cell using a single p-n junction.

About three fourths of Earth's surface is covered by water, leaving only about one fourth of the surface covered by land masses. One half of the available land mass is not available for siting ground-mount solar panels due to heavy urbanization, mountain ranges, swamps, permafrost, and soils with expansive clays near the surface. About 40% of Earth's available land is needed to grow crops and livestock. This need will need to increase, as the world's population is expected to reach 10 billion people by 2050. Accordingly, there is a land constraint or finiteness for deployment of large-scale solar which will become apparent in the coming decades.

Placement of solar panels over bodies of water, however, holds great promise for renewable energy generation, and could help to address the future land-constraint problem. There are several benefits to floating photovoltaic (FPV) systems. The underlying water evaporates upward and cools the panels, which leads to an increase in panel conversion efficiency of 10-20%. This cooling helps to increase energy generation per unit of area as compared to ground-mount solar sites. It takes only two surface acres of FPV solar to generate one megawatt (MW) of electricity, versus seven acres of ground-mount solar installations. Additionally, the floating solar arrays retard sunlight from entering the water column, which prohibits formation and accumulation of algae and other biologic surface water plants such as duckweed. Floating solar arrays, although their capital expense is slightly higher than ground-mount solar, are much easier to install and maintain, leading to reduced operating expenses over the lifetime of the floating solar array. Moreover, in arid and semi-arid regions such as the Western United States, floating solar arrays lower evaporation rates by up to 70% when placed on water reservoirs.

In addition to these FPV benefits there are new technologies now being developed for commercialization that can enhance the conversion efficiency of current silicon based solar panels. The most promising of these technologies are materials called “Perovskites.” Perovskites are highly structured crystallographic materials which when placed onto a solar panel can further boost the conversion efficiency by another seven-15%. A Perovskite solar panel can be produced by applying a Perovskite film to a solar panel, by ink-jet printing onto a solar panel, or by spin coating a solar panel, or by other surface deposition processes. Solar panels with Perovskites have already reached 25.2% conversion efficiency. Oxford PV in the United Kingdom is one company amongst others who are on the threshold of commercializing this technology.

Considering that solar panel conversion efficiency will eventually reach its upper limit at around 33 percent (33%), plus the additional gain from placement on surface water bodies due to evaporative cooling of 10-15%, and the incorporation of Perovskite films to further boost conversion efficiency, it is feasible that a “compound efficiency” for conversion could reach 50% by the year 2025. The ramifications of this efficiency improvement could be far-reaching for achievement of zero emissions energy generation on a global scale.

Hydrogen holds great promise as the future energy source which can lead to the decarbonization of motor transport and electricity generation. The major sources of greenhouse gas emissions that contribute to global warming in the United States are 35% for transportation, 35% for electricity generation, and about 20% for industrial uses. If hydrogen can be produced from a zero-carbon pathway using renewable energy sources such as solar, wind, hydroelectric, and other sources, then an orderly transition can begin to full decarbonization and eventual mitigation and “softening” from the impacts of global warming.

The present invention is a step to transforming our energy use to zero-emissions.

Hydrogen fuel cells have been proposed on several occasions beginning in the 1970s in response to the Arab Oil Embargo, and more recently as a potential solution to address global warming. Most major automaker OEMs realize that hydrogen-powered vehicles will become the best practical means of creating a zero-emissions transportation sector without sacrificing performance and customer acceptance. In the late 1990s and early 2000s, there was building momentum for hydrogen fuel-cell vehicles due in part to improvements in engineering of the fuel cells and falling costs for their manufacturing. At the same time, however, the process of hydraulic fracturing (“fracking”) of shale formations was underway in Texas and would lead to an explosion of commercial activity in the oil and gas sector to identify new shale sources for development. This surge in oil and gas development using fracking would once again push hydrogen fuel cells and the hydrogen economy into the background. From 2002 through 2012, major shale production basins would be developed in Texas, Louisiana, Colorado, North Dakota, Pennsylvania, Ohio, and West Virginia. The Marcellus shale play in the Appalachian Basin alone is projected to hold more than 200 trillion cubic feet of recoverable natural gas.

In 2010 a revival of electric-powered vehicles started to emerge in response of addressing the global warming situation. General Motors designed and built the Chevrolet Volt, a range extended electric car. A new car company, Tesla, Inc., was getting started in California, selling all electric vehicles. These new electric vehicles were powered with a new battery chemistry based primarily on lithium. Sales of the Chevrolet Volt were low primarily due to the falling costs of gasoline made possible by the success of fracking. The raw materials for manufacturing lithium ion batteries are lithium, cobalt, nickel, copper, and graphite. These materials are all finite-sources that need to be extracted through mining and then refined and shipped to the point of manufacture. The amount of energy required to obtain these materials is enormous. This practice also leads to huge environmental site degradation due to poor reclamation plans and execution, such as acid mine drainage (AMD) in the case for nickel mining.

Hydrogen, on the other hand, is the most abundant element in the Universe. It represents about 75% of the total mass of the Universe. Hydrogen does not occur in a “free state;” it is mostly bound to other elements, for example in water, and must be separated in order to be used as a commodity. Most hydrogen to date is manufactured from a process known as Steam Methane Reforming (SMR). Methane is reacted with pressurized steam and then undergoes a pressure swing adsorption step, which creates molecular hydrogen, but also creates a large by-product of carbon dioxide, which contributes to global warming. This pathway has been identified in the literature as Gray Hydrogen. There is also Blue Hydrogen, which is the SMR process followed by Carbon Capture Storage (CC S) of the carbon dioxide byproduct into a suitable geologic formation for sequestration.

Green Hydrogen is the process of using a renewable energy source such as wind and solar power to split water molecules into pure hydrogen and oxygen with the capture and storage of the hydrogen. Electricity powers a machine called an electrolyzer which converts the water feed into its gaseous components. The cost of electricity is the largest input for making hydrogen through water electrolysis. Electrolyzers have been used since the 1920s in countries such as Canada and Norway, who have large hydroelectric power resources serving as low-cost energy inputs to split water into hydrogen.

The biggest hurdle to making hydrogen fuel-cell vehicles mainstream for transportation has been the lack of a suitable refueling infrastructure. It is the classic “chicken and egg” problem. Automaker OEMs and trucking companies will not make fuel cell vehicles in large numbers because there are not enough refueling stations. Conversely, energy and hydrogen suppliers will not build an infrastructure of hydrogen refueling stations because there are not enough vehicles to use the stations.

The proposed invention describes a pathway to generate green hydrogen by using floating solar arrays placed onto gravel pits, sand pits, rock quarries and other suitable bodies of surface water. For example, the Eisenhower Interstate Highway System was built by using sources of aggregates extracted within a half-mile from the highway, thereby creating gravel and sand pits close to the highway. These pits usually fill with ground water. Additionally, interstate highways, as well as many other roads, often have borrow pits from which soil has been excavated to create embankments or overpasses. The borrow pits, which are often located near entrance/exits to limited-access highways, usually become filled with water.

The water temperature of gravel/sand/quarry lakes is very favorable year-round for adding to solar panel conversion efficiency by evaporative cooling. These gravel/sand/quarry pits are also less prone to freezing over due to subterranean groundwater movement. The improved conversion efficiency due to evaporative cooling of the solar panels, and the improved energy density of only two acres of solar panels to generate 1MW of power creates a favorable system for generating green hydrogen with zero emissions. The invention brings all the inputs necessary to generate green hydrogen into one single location: solar power, water, and electrolysis.

Furthermore, gravel pits/sand pits/rock quarries contain relatively clean water which makes deionization of the makeup water for the electrolyzer much easier. Gravel pits/sand pits/rock quarry lakes are also typically free from shading obstructions such as large buildings or other human-made obstructions. The water can also be used to clean the solar panels to avoid soiling issues and degradation of the energy potential. The solar arrays can be “directly connected” to the electrolyzer for hydrogen generation and can avoid the costs and administration of connecting to the electric grid as well as the time to obtain approval and connection.

An important aspect of the invention is the ability to generate green hydrogen at a low cost right where it is to be consumed in refueling transportation vehicles. The transportation and delivery of hydrogen to the point of use is the largest cost factor in the use of hydrogen fuel cells. By taking advantage of the many thousands of water-filled pits located in close proximity to highways, the cost of hydrogen to power fuel cells will be significantly decreased. Generation of green hydrogen, and the equipment components needed to compress, store, and dispense it, will fall dramatically as this system scales up to wider adoption.

A further advantage of using water-filled pits is the increased likelihood of obtaining local permits for extraction of gravel and sand and other quarried materials. Quarriers often encounter objections from local residents and/or government to obtaining permits. As a result, quarriers must locate extraction sites farther away from residential areas, which causes increased costs for transportation of the extracted material to the local building site. A local municipality may be more inclined to permit a nearby extraction site premised on the site being used, after quarrying is complete, for a local hydrogen-generation plant.

This pathway can be replicated anywhere in the world and forms a “backbone” which can scale up zero emissions transportation, and ultimately to stationary sources from hard-to abate sectors such as steel, cement, and chemicals manufacturing. Eventually a tipping point is reached where centralized production of hydrogen takes over and current infrastructure for liquid fuels and natural gas can be used for transport.

The zero-carbon green hydrogen production process of the present invention is based on using electrolysis powered by floating solar panels deployed on stratified bodies of water like quarry lakes, gravel pits, sand pits, borrow pits, and deep hydroelectric reservoirs. These select group of surface water bodies contain sizable volumes of cold water within their basins.

Placement of floating solar panels on bodies of water has proven to add additional conversion efficiency for higher electricity production due to the cooling effects of evaporation underneath the panels. This natural cooling effect adds anywhere from 7-22% to a solar-panel rated conversion efficiency. This increase leads to a superior driver of electric current versus traditional ground mount solar sites and wind turbine farms. It only takes two surface acres of floating solar panels to generate one MW versus seven acres of ground-mounted solar to generate one MW. This smaller surface area for floating solar panels leads to an effective power density of 125 W/m² (watts per square meter). Conversely, wind turbine farms only have a power density of one to two W/m². Ground-mounted solar has a nominal power density of 25-30 W/m².

Water has a very high specific heat number. Specific heat is a measure of how much energy it takes to raise the temperature of one kg of water by one degree C. at standard atmospheric pressure. It takes 4180 joules of energy to raise the temperature of one kg water by one degree C. As a result, the cold water lying at depth in stratified water bodies is a highly stable mass. The air mass overlying a stratified water body has a much lower specific heat number. It takes only 700 Joules of energy to raise the temperature of one kg of air by one degree C. As time moves forward the atmosphere will continue to warm which increases the effective temperature difference between cold water in reservoirs and overlying air masses which will lead to increased evaporation mechanics to increase electricity for electrolysis and water splitting.

Water vapor is a greenhouse gas. Increased warming of the atmosphere leads to ever greater amounts of evaporation which fuels increases in water vapor on a global basis. This water eventually condenses and falls back to earth as rain, snow, and sleet. This now terrestrial water ultimately finds its way back into quarry lakes, gravel pits, and hydroelectric reservoirs completing the hydrological cycle.

The present invention uses solar as a low-cost input for electricity to split water into hydrogen and oxygen. When hydrogen is burned in a fuel cell its two main byproducts are heat and pure water. This water from using hydrogen as a fuel evaporates into the atmosphere and completes the “closed loop” cycle. So in effect the present invention does not consume water to make green hydrogen, it only temporarily borrows the water to create hydrogen fuel.

An additional use for the present invention is to co-locate it with one or more other intermittently-available renewable energy sources. For example, the body of water could be a reservoir formed by a hydroelectric dam. The solar panels will generate electricity during the day and the generators in the dam will generate electricity during the night, or, if necessary, also during the day if there is a large demand for electricity. Or, there could be a wind turbine farm, a geothermal power plant, or any other nonfossil-fuel power source collocated with the body of water.

### SUMMARY OF THE INVENTION

The present application discloses a uniquely-sited electrolysis plant for converting water to molecular hydrogen and molecular oxygen. The electrolysis plant is powered by a renewable-energy generator. In the preferred embodiment, the renewable-energy generator is a solar-cell array, preferably perovskite-enhanced solar panels, and is located in or on a non-navigable body of water or a non-navigable portion of a body of water. The electrolysis plant supplies hydrogen to a nearby transportation refueling station and/or to a nearby industrial or commercial facility. In an embodiment of the invention, the renewable-energy generator is a wind turbine used instead of solar power to power the electrolysis plant.

### BRIEF DESCRIPTION OF THE DRAWINGS

The organization and manner of the structure and operation of the invention, together with further objects and advantages thereof, may best be understood by reference to the following description, taken in connection with the accompanying non-scale drawings.

FIG. 1 is a layout view of the preferred embodiment of the invention.

FIG. 2 is a layout view of the floating photovoltaic system of the preferred embodiment of the invention.

### DETAILED DESCRIPTION OF THE PREFERRED EMBODIMENTS OF THE INVENTION

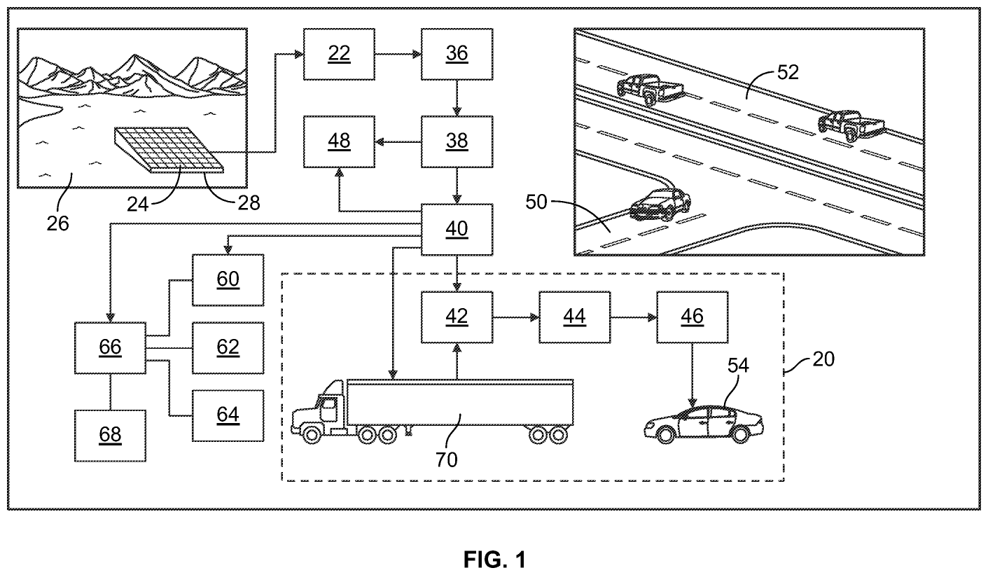

The preferred embodiment of the invention, as shown schematically in FIG. 1, comprises a transportation refueling station 20, an electrolyzer 22, and a solar-cell array 24.

Solar-cell array 24 is an FPV system connected to a body 26 of non-navigable water or on a non-navigable portion 28 of a body 26 of water. Please note that the FPV can be placed on a navigable portion of a body 26, if permitted, but doing so renders than portion non-navigable. In the preferred embodiment, solar-cell array 24 floats on the body 26 of water. In other embodiments, solar-cell array 24 is built rigidly to a structure standing on the bed of the body 26 of water.

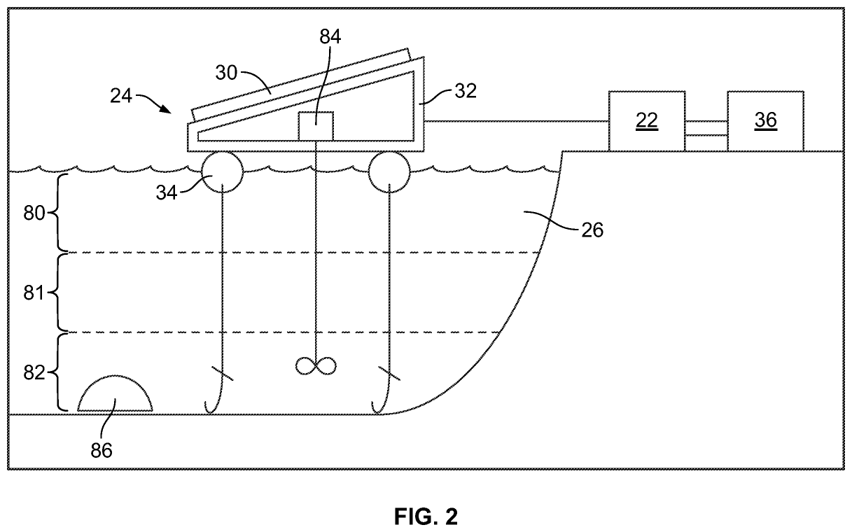

Solar-cell array 24, as shown in more detail in FIG. 2, includes one or more solar cell panels 30, a support structure 32 (which includes one or more floats 34), and an anchoring system 36. Preferably, solar cell panels 30 include a perovskite material. Complete floating FPV systems are available from, for example, Ciel et Terre USA, Petaluma, California, United States of America.

Examples of bodies 26 of surface water suitable for the preferred embodiment include but are not limited to:
quarry lakes;
gravel and sand mining pits;
borrow pits;
waste-water treatment lagoons/ponds;
cooling ponds;
mining tailings/spoils impoundments;
coal ash storage basins at former coal fired power stations;
hydroelectric dams-reservoirs;
municipal water-storage reservoirs;
fish hatchery ponds;
aquaculture ponds;
brine ponds used for underground storage of natural gas and hydrocarbons;
artificial water reservoirs, such as lagoons created to hold water for fracking or other purposes;
natural lakes and ponds (with private landowner permission); and
protected bays, estuaries, fjords and other public-protected water bodies (with government approval).

Electrolyzer 22 is located near body 26. Electrolyzer 22 is powered by solar-cell array 24. Electrolyzer 22 can be a proton electrolyte membrane, also known as a polymer-electrolyte membrane (PEM) electrolyzer, an alkaline electrolyzer, a solid oxide (SO) electrolyzer, an anion exchange membrane, or any other available type of electrolyzer. Electrolyzer 22 includes a deionizer for input water, if necessary, and is connected to a compressor 36 and a pump 38 for the hydrogen produced.

In a PEM, hydrogen ions combine at the cathode with electrons from the external circuit to form hydrogen gas:

Anode Reaction: 2H₂O→O₂+4H⁺+4e⁻

Cathode Reaction: 4H⁺+4e⁻→2H₂

In a SO electrolyzer, very high temperatures, on the order of 700 to 800 C, are required. This type of electrolyzer is adaptable for use in, for example, the cooling pond of a nuclear reactor, where the electrolyzer can use the waste heat of the reactor.

Electrolyzer 22 may include a rectifier and/or inverter as necessary.

The outputs of electrolyzer 22 are molecular oxygen and molecular hydrogen. Molecular hydrogen is preferably pumped to storage tank 38. Alternatively, the hydrogen can proceed directly to refrigeration. The oxygen can simply be released to the atmosphere or can be liquified and sold separately. Alternatively, the oxygen can be captured and returned to body 26 to support aeration and to maintain the dissolved oxygen level.

The hydrogen output from electrolyzer 22 is very pure. Preferably, it meets the guidelines of SAE J2719, Hydrogen Fuel Quality for Fuel Cell Vehicles, the disclosure of which is incorporated herein by reference. It need only be compressed, refrigerated, and dispensed at transportation refueling station 20. Accordingly, the hydrogen is preferably cooled in first refrigerator 40.

Transportation refueling station 20 is preferably designed to meet the guidelines of SAE J2601, Fueling Protocols for Light Duty Gaseous Hydrogen Surface Vehicles, the disclosure of which is incorporated herein by reference. Transportation refueling station 20 has at least one storage tank, but preferably has a cascade 42 of storage tanks and one or more metering pumps or dispensers 46, as shown in, for example, FIG. A-1 of SAE J2601. Preferably, the hydrogen is cooled to −40 C (for a T40 station) prior to filling. Accordingly, a station refrigerator 44 cools the hydrogen to the proper temperature before dispensing into a Compressed Hydrogen Surface Vehicle. Metering pump 44 preferably is designed in accordance with SAE J2600, Compressed Hydrogen Surface Vehicle Fueling Connection Devices. Metering pump 44 may meet SAE J2799, Hydrogen Surface Vehicle to Station Communications Hardware and Software, the disclosure of which is incorporated herein by reference.

Transportation refueling station 20 may optionally have a retail facility, such as an automotive repair facility, a restaurant or café, washrooms, and a convenience store. Refueling station 20 is, in the preferred embodiment of the invention, located near an exit 50 to a divided highway 52. Exits to divided highways, such as Interstate Highways, are often constructed with overpasses, requiring the use of a borrow pit. Gravel and sand pits are often located near highway exits as well. By locating refueling station 20 near an exit, there is usually a borrow pit, gravel pit, or sand pit, or other quarry, nearby to act as body 26 and there is convenient access for motor vehicle traffic on highway 52. Refueling station 20 may, of course, be located using any criteria for siting a traditional gasoline refueling station, such as at a crossroad.

The power-using components of transportation refueling station 20, such as pumps and lights, are preferably powered by solar-cell array 24. In one embodiment, however, transportation refueling station 20 has a stationary fuel cell 48. Stationary fuel cell 48 uses hydrogen made in electrolyzer 22 to generate electricity for those power-using components. Alternatively, automotive refueling station 20 may include a land-mount solar-cell array to provide electrical power, or may connect to a local electrical grid.

In use, electrolyzer 22 draws input water either from body 26 or, alternatively, from another source, such as a ground-water pump or a municipal water supply. Electrolyzer 22, preferably powered by the electricity generated by solar-cell array 24, de-ionizes the input water, if necessary, and electrolyzes it to hydrogen and oxygen. The hydrogen is compressed in compressor 36 and pumped to storage tank 38. From storage tank 38, hydrogen is removed as needed and pumped to first refrigerator 40, from which it is pumped to cascade 42.

Compressor 42 and refrigerator 40 are preferably powered by electricity from solar-cell array 24. Alternatively, compressor 42 and refrigerator 40 are powered by stationary fuel cell 48. These power sources may also obtain power from a land-mount solar-cell array, or may connect to a local electrical grid.

A customer operating a motor vehicle 54, such as a Compressed Hydrogen Surface Vehicle, exits the nearby highway 52, enters refueling station 20, and refuels at dispenser 46 in a manner similar to refueling of a gasoline-powered vehicle. Motor vehicle 54 may be a heavy-duty vehicle, a medium-duty vehicle, or a light-duty vehicle. Metering pump 44 preferably comprises at least two meters, one delivering hydrogen at 350 bar for a heavy-duty vehicle and one delivering hydrogen at 700 bar for a light-duty vehicle. In other embodiments, other delivery pressures may be used.

Because hydrogen is produced nearby, the cost of transporting it to refueling station 20 is basically the cost of a pipeline and pump, plus land costs. There is, in the preferred embodiment, no need for delivery trucks. Because highly-efficient FPVs are being used, electricity costs to run the electrolyzer and associated systems, such as a compressor and pumps, is low.

In other embodiments, means, other than a pipeline, of transporting the hydrogen to the fueling station may be used. In one other embodiment, a tube trailer is used to transport compressed gaseous hydrogen from the electrolyzer location to the refueling station. In another embodiment, the hydrogen is liquified at or near the electrolyzer location and is transported to the refueling station by a bulk cryogenic tanker. In yet another embodiment, the gaseous hydrogen is absorbed by a liquid organic hydrogen carrier (“LOHC”). The LOHC may be an unsaturated hydrocarbon such as toluene, N-ethyl carbazole, or Dibenzyltoluene. The LOHC is hydrogenated at or near the electrolyzer location and transported, for example by tanker, to the refueling station, where it is de-hydrogenated. In yet another embodiment, the gaseous hydrogen is stored in a solid-state hydrogen carrier material, including by way of example a metallic hydride such as magnesium hydride. In yet another embodiment, the gaseous hydrogen is carried by a liquid siloxane hydrogen carrier compound, such as the ones offered by HySiLabs of Aix-en-Provence, France.

In another embodiment, also shown schematically in FIG. 1, electrolyzer 22, solar-cell array 24, and body 26 are located to serve one or more other direct or indirect users of hydrogen. Hydrogen from electrolyzer 22 is pumped to a power generator 66, which uses hydrogen to generate electricity and/or steam, which are then sold to an indirect user, such as an industrial facility 60, a commercial establishment 62, or a municipality 64. The electricity can be used to power the lights and machinery of industrial facility 60, such as a manufacturing plant. In the case of a commercial establishment 62, electricity from power generator 66 can be used for, among other examples, lighting and HVAC at a shopping mall or an office building. In the case of a municipality 64, the electricity is used for residences, street lights, and commercial buildings such as retail stores.

Alternatively, or additionally, steam generated by power generator 66 can be used. Steam is useful in many industrial processes, as it is an excellent reservoir for thermal energy, and is useful both for heating and for propulsion or drive force. Steam from steam generator 66 can be used to heat industrial facility 60 or commercial establishment 62 in winter or can be used to drive pumps or compressors in either location. Steam is also useful for the manufacture of items as diverse as bricks and beer. By generating steam from hydrogen as described above, the user of power generator 66 avoids the costs and environmental effects of using carbon fuels and avoids the transient nature of solar power.

A further option is to locate electrolyzer 22 near a facility that directly uses hydrogen. In this embodiment, a user 68 of hydrogen is located adjacent electrolyzer 22. Some or all the hydrogen produced is compressed and pumped to end-user 68, who may be, for example, a fertilizer manufacturer. Hydrogen is used in, for examples, the commercial fixation of nitrogen from the air, hydrogenation of fats and oils, production of methanol, production of rocket fuel and race car fuel, welding, production of hydrochloric acid, and the reduction of some metallic ores. End-user 68 obtains hydrogen at a lower cost than having it delivered by truck, and avoids the environmental damage caused by SMR.

In yet another embodiment, solar-cell array 24 is a land-mounted system. Input water can be obtained from a nearby body of water, from a ground-water supply, or from a municipal water supply.

In yet another embodiment, hydrogen from electrolyzer 22 is compressed and pumped to a tank truck 70, as shown in FIG. 1. When tank truck 70 is full, it is driven to refueling station 20 where the hydrogen is transferred to cascade 40. In this embodiment, the costs of a pipeline from compressor 36 to refueling station 20 are avoided. Alternatively, tank truck 70 can be parked at transportation refueling station 20 and connected to second refrigerator 44 and used, in effect, in place of cascade 42.

Moreover, tank truck 70 can haul hydrogen to power generator 66 or end user 68, to avoid the costs of pipelines to those facilities.

Alternatively, tank truck 70 can be parked at refueling station 20 and connected to metering pump 44. Tank truck 70 takes the place of a storage tank 40 or a cascade 42. Refueling of motor vehicle 54 proceeds without the necessity of a storage tank 40 or a cascade 42.

In yet another embodiment, thermal destratification technology can be used to increase efficiency of solar-cell array 24. A body 26 of water is likely to stratify into three layers, a top layer, or epilimnion 80, a middle layer, or metalimnion 81, and a bottom layer, or hypolimnion 82. Epilimnion 80 will be warmer than hypolimnion 82. A thermal destratification device, powered by solar-cell array 24, can be used to reduce stratification. For example, a horizontal circulator 84 is available from Kasco Marine, Prescott, Wisconsin. Alternatively, a diffused aeration can be used. Aerator 86, mounted on support structure 32 or separately, sequentially injects bursts or pulses of compressed air or gas into hypolimnion 82. These types of aerators are available from Pulsair Systems, Inc., of Bellevue, Washington. Aerator 86, powered by solar-cell array 24, can have its own compressor or can use oxygen generated by electrolyzer 22, which would otherwise be vented to atmosphere.

The re-injection of oxygen generated by electrolyzer 22 into the body of water has a beneficial effect on that body of water. Increased oxygen in what would otherwise be stagnant water increases nutrient uptake and conversion efficiency which enhances the growth and development of vegetation. For instance, oxygen will oxidize organic phosphate into inorganic phosphate which can then be readily used by plants. Additionally, increased oxygen will allow bacteria in the body of water to break down organic waste in the body of water more easily and quickly and decrease the likelihood of formation of hydrogen sulfide or methane. Accordingly, the re-injection of oxygen generated by electrolyzer 22 is useful both for body 26 of water and for a wastewater treatment plant.

In yet another embodiment, wind power is used instead of solar power. In this embodiment, the invention comprises a transportation refueling station 20, an electrolyzer 22, and a windmill. The windmill provides the electrical power for electrolyzer 22. All other aspects of the invention are as described above.

While preferred embodiments of the present invention are shown and described, it is envisioned that those skilled in the art may devise various modifications of the present invention without departing from the spirit and scope of the appended claims.

1. A system comprising:
a transportation refueling station comprising a hydrogen storage tank and a metering pump;
a solar-cell array connected to a body of water, the body of water being at least one of a quarry lake, a gravel mining pit, a sand mining pit, a borrow pit, a waste-water treatment lagoon, a waste-water treatment lagoon, a cooling pond, a mining tailings impoundment, a coal ash storage basin, a hydroelectric dam reservoir, a municipal water-storage reservoir, a fish hatchery pond, an aquaculture pond, a brine pond, and an artificial water reservoir,
the body of water having a bed, and
the solar cell array is configured to float on the body of water or to stand on the bed; and
an electrolyzer powered by the solar-cell array, the electrolyzer producing oxygen and hydrogen from input water, the hydrogen being transported to the hydrogen storage tank.

2. The system of claim 1, wherein the solar-cell array comprises a Perovskite material.

3. The system of claim 1, wherein the input water has a source, the source comprising at least one of the body of water, a local ground-water supply, and a local municipal water supply.

4. The system of claim 1, wherein the transportation refueling station further comprises a hydrogen refrigerator, the hydrogen refrigerator receiving the hydrogen from the electrolyzer, cooling the hydrogen, and providing the cooled hydrogen to the storage tank.

5. The system of claim 1, further comprising an oxygen refrigerator and oxygen storage tank, the oxygen refrigerator receiving the oxygen from the electrolyzer, cooling the oxygen, and providing the cooled oxygen to the oxygen storage tank.

6. The system of claim 1, wherein the transportation fueling station further comprises a retail facility, the retail facility comprising at least one of an automotive repair facility, a restaurant, a washroom, and a convenience store.

7. The system of claim 1, wherein the retail facility comprises a power-using component, and the power-using component obtains power from at least one of the solar-cell array, a land-mounted solar array, and a local electric grid.

8. The system of claim 1, wherein the metering pump comprises a heavy-duty pump and a light-duty pump.

9. The system of claim 1, further comprising a thermal destratification device in the body of water, the thermal destratification device requiring power, and the power being provided by the solar-cell array.

10. The system of claim 9, wherein the thermal destratification device comprises a horizontal circulator or an aerator receiving oxygen from the electrolyzer.

11. The system of claim 1, further comprising a power generator, the power generator receiving hydrogen from the electrolyzer and using the hydrogen to produce at least one of electrical power and steam power for use by a third-party facility.

12. A system comprising:
a hydrogen refrigerator connected to a hydrogen storage tank;
a solar-cell array connected to a body of water, the body of water being at least one of a quarry lake, a gravel mining pit, a sand mining pit, a borrow pit, a waste-water treatment lagoon, a waste-water treatment lagoon, a cooling pond, a mining tailings impoundment, a coal ash storage basin, a hydroelectric dam reservoir, a municipal water-storage reservoir, a fish hatchery pond, an aquaculture pond, a brine pond, and an artificial water reservoir,
the body of water having a bed,
the solar-cell array configured to float on the body of water or configured to stand on the bed,
the solar-cell array comprising a perovskite material;
an electrolyzer powered by the solar-cell array, the electrolyzer obtaining input water from at least one of the body of water, a local ground-water supply, and a municipal water supply, the electrolyzer producing oxygen and hydrogen, the electrolyzer providing the hydrogen to the hydrogen storage tank, the hydrogen refrigerator cooling the hydrogen and providing the cooled hydrogen to a user of hydrogen; and
the user comprising at least one of a transportation refueling station comprising a metering pump connected to the hydrogen refrigerator, the metering pump comprising at least one of a light-duty pump and a heavy-duty pump, an industrial facility, a commercial establishment, and a municipality.

13. The system of claim 12, further comprising an oxygen refrigerator and oxygen storage tank, the oxygen refrigerator receiving the oxygen from the electrolyzer, cooling the oxygen, and providing the cooled oxygen to the oxygen storage tank.

14. The system of claim 13, wherein the oxygen is returned to the body of water.

15. The system of claim 12, wherein the user comprises the transportation fueling station and the transportation fueling station comprises a retail facility, the retail facility comprising at least one of an automotive repair facility, a restaurant, washrooms, and a convenience store.

16. The system of claim 12, wherein the user comprises a retail facility, the retail facility comprising a power-using component, and the power-using component obtains power from at least one of the solar-cell array, a land-mounted solar array, and a local electric grid.

17. The system of claim 12, further comprising a power generator, the power generator receiving hydrogen from the electrolyzer and using the hydrogen to produce at least one of electrical power and steam power for use by user.

18. The system of claim 12, further comprising a thermal destratification device comprising at least one of a horizontal circulator and an aerator.
